(19) United States
(12) Patent Application Publication
(10) Pub. No.: US 2016/0221119 A1
(43) Pub. Date: Aug. 4, 2016

(54) DEVICE FOR LASER STRUCTURING HUBS OF VALVE TRAIN COMPONENTS

(71) Applicant: Mahle International GmbH, Stuttgart (DE)

(72) Inventors: Ralf Rieger, Steinheim a.d. Murr (DE); Christoph Unrath, Urbach (DE)

(21) Appl. No.: 15/011,203

(22) Filed: Jan. 29, 2016

(30) Foreign Application Priority Data
Jan. 30, 2015 (DE) 102015201689.7

(51) Int. Cl. B23K 26/03; B23K 26/02; B23K 26/00

(52) U.S. Cl. CPC B23K 26/032; B23K 26/0084; B23K 26/02

(57) ABSTRACT

A laser structuring device for a hub of a valve train component may include at least one load carrier for storing and providing at least two valve train components, at least one laser for laser structuring a hub of at least one valve train component, and at least one robot arm having a gripping device for gripping, positioning and holding the at least one valve train component during the laser structuring. The at least one robot arm may be movable to position the at least one valve train component into a machining position.

### CROSS-REFERENCE TO RELATED APPLICATIONS

This application claims priority to German Patent Application No. 10 2015 201 689.7, filed Jan. 30, 2015, the contents of which are hereby incorporated by reference in its entirety.

### TECHNICAL FIELD

The present invention relates to a device for laser structuring hubs of valve train components. Moreover, the invention further relates to a laser structuring method using such a device.

### BACKGROUND

In order to be able to reliably fix valve train components, for example cams, on an associated shaft, the connecting surfaces coming into contact with one another are often structured, that is roughened, thereby enabling an increase in the transmissible torque. A laser structuring or surface roughening used for this purpose is carried out in particular in the region of thermal join connections and/or interference fits.

A device for introducing structures in the form of preferably line-like recesses in contact surfaces of two bodies that are connected to one another in a force-locking manner is known from DE 103 25 910 A1, wherein the recesses to be introduced in the contact surface to be treated are introduced by means of a laser.

Another generic device for introducing recesses into contact surfaces of bodies that are connected to one another in a force-locking manner by means of radiation treatment using a laser is known from DE 103 62 303 B4. This device also has a swivel mirror device including a swivel mirror for deflecting the laser beam to the contact surface of the body to be treated as well as a support device for clamping the body, wherein the support device is configured as a rotatable rotary table and the at least one swivel mirror device is arranged on the outer circumference of the rotary table.

Known from WO 2010/127862 A1 is a laser station for structuring inner circumferential surfaces of a workpiece, for example a cam of a camshaft or a big end bore of a connecting rod, using at least two 3D lasers that are offset with respect to one another. The laser beam of the at least two 3D lasers is controllable and/or focusable in each case in the X-, Y- and Z-direction, wherein the lasers are arranged above, laterally offset and inclined towards the inner circumferential surface. Through this, effective structuring of workpieces is to be enabled.

### SUMMARY

The present invention is concerned with the problem of providing for a device of the generic kind an improved or at least alternative embodiment, which can in particular be used in a flexible manner.

This problem is solved according to the invention by the subject matter of the independent claim(s). Advantageous embodiments are subject matter of the dependent claims.

The present invention is based on the general idea to no longer use, as previously, a fixed laser station with, for example, deflection mirrors and a rotatable rotary table on which the components to be machined, for example valve train components, are fixed, but rather to provide a robot arm with a gripping device which, depending on the programming, is capable during laser structuring of quickly, flexibly and exactly holding the component, that is, the respective valve train component. The device according to the invention for laser structuring hubs of valve train components has at least one load carrier for storing and providing at least two valve train components and at least one laser for laser structuring a hub of the at least one valve train component. Essential for the invention is the robot arm with its gripping device for gripping, positioning and holding at least one valve train component during laser structuring, wherein this robot arm is also designed for removing the at least one valve train component from the load carrier and for feeding it to the laser. Upon completion of the laser structuring, the robot arm, by using a gripping device, is of course also capable of putting the machined valve train component back into the load carrier. Using the device according to the invention allows a significantly more flexible operation since the gripping device and the robot arm can be adapted in a simple manner for many different valve train components by means of adequate programming. In particular, changing a corresponding rotary table, for example, is no longer required. If the robot arm with its gripping device is also capable of gripping a plurality of valve train components at the same time and to hold them during laser structuring, it is also possible to significantly reduce the cycle time of the actual laser structuring.

Expediently, at least two lasers, in particular three 3D lasers, are provided for simultaneously laser structuring at least one valve train component. Here, it is conceivable, for example, that one of the at least two lasers is arranged above, and the other one is arranged below the valve train component to be machined. Of course, it is also possible to provide a corresponding laser station including, for example, six lasers, wherein in this case, the gripping device is capable of simultaneously gripping, for example, three valve train components and thus of simultaneously holding them during laser structuring.

Expediently, the at least one robot arm is movable. Due to the movability of the robot arm, the robot arm can be moved faster and therefore a reduction of the cycle time can be achieved. Of course, it is also conceivable here that while the robot arm moves, its gripping device is moved at the same time so that the actual time between two stations can be further reduced.

In a further advantageous embodiment of the solution according to the invention, a camera for detecting the position of the valve train component is arranged on the at least one robot arm. In addition, a control device can be provided, which control device is communicatively connected to the camera and readjusts the gripping device upon detection of a positional deviation. Thus, such a camera on the robot arm is able, for example, to securely and precisely grip valve train components even if they are slightly shifted in the load carrier and to feed them in a precise position to the respective laser because the camera is able to detect and compensate positional deviations. This makes it possible that significantly lower tolerance requirements in terms of the positioning of the individual valve drive components have to be met, as a result of which costs can also be saved.

Expediently, the control device includes a monitoring device that generates an optical and/or acoustic monitoring signal if the laser structuring process has been performed correctly. Such optical and/or acoustic control can be received and recorded, for example by means of a suitable receiver, thereby enabling improved quality assurance. Of course, it is also conceivable that such an optical and/or acoustic monitoring signal is checked only randomly by a worker.

The present invention is further based on the general idea of providing an improved laser structuring method using the previously described device, wherein, in first instance, a load carrier including at least one valve train component to be lasered is provided. The load carrier serves as a depot and is designed for accommodating a plurality of valve train components. Subsequently, the at least one robot arm including the gripping device is moved to the load carrier, wherein, while moving, a movement of the robot arm with respect to its joint axis can take place, whereby time can be saved. Subsequently, the control device localizes via the camera the at least one valve train component to be gripped and aligns the gripping device accordingly. For example, it is conceivable here that the camera detects misplacements of the valve train component to be gripped and aligns the gripping device of the robot arm accordingly so that the latter can grip the valve train component to be machined in a reliable and exact manner. Now, the gripping device feeds the at least one valve train component to a first machining position in which at least one laser laser-structures the at least one valve train component. Subsequently, the at least one valve train component can be put back into the load carrier by means of the gripping device and the robot arm, or can be fed to at least one further machining position in which a further laser structuring of the hub of the valve train component is carried out. Such a valve train component to be machined and/or lasered can be, for example, a cam, a sensor wheel or a drive wheel. Theoretically, it is of course also possible that at least two robot arms each having one gripping device are provided, wherein the one robot arm grips with its gripping device at least one valve train component and feeds it to the laser, while the other robot arm with its gripping device fixes a valve train component to be machined specifically during the laser structuring.

Further important features and advantages of the invention arise from the sub-claims, from the drawings and from the associated description of the figures based on the drawings.

It is to be understood that the above-mentioned features and the features still to be explained hereinafter are usable not only in the respective mentioned combination, but also in other combinations or alone, without departing from the context of the present invention.

Preferred embodiments of the invention are illustrated in the drawings and are explained in greater detail in the following description, wherein same reference signs refer to same or similar or functionally identical components.

### BRIEF DESCRIPTION OF THE DRAWINGS

In the figures, schematically,

FIG. 1 shows a device according to the invention for laser structuring hubs of valve train components,

FIG. 2 shows an illustration as in FIG. 1, but with two lasers and two robot arm,

FIG. 3 shows a robot arm with a gripping device for simultaneously gripping two valve train components.

### DETAILED DESCRIPTION

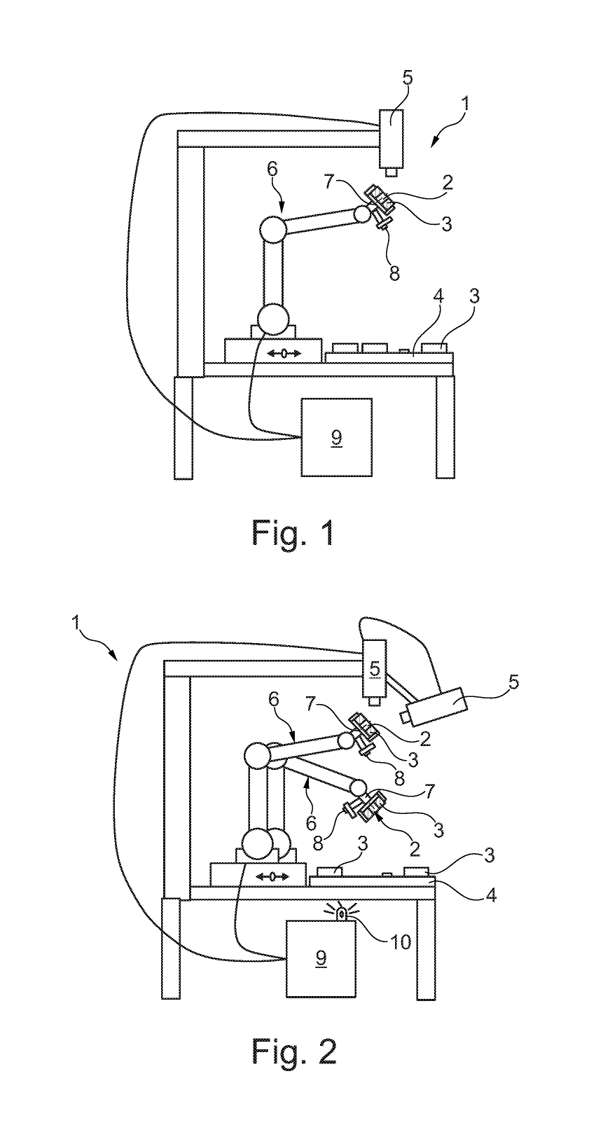

According to the FIGS. 1 and 2, a device 1 according to the invention for laser structuring hubs 2 and valve train components 3, for example cams, sensor wheels or drive wheels, has at least one load carrier 4 for storing and providing at least two valve train components 3. Also provided is at least one laser 5 for laser structuring the hub 2 of the at least one valve train component 3, wherein the laser 5 can be designed as a so-called 3D laser, for example. The device 1 according to the invention also has at least one robot arm 6 each having one gripping device 7 for gripping, positioning and holding at least one valve train component 3 during laser structuring. Through its gripping device 7, the laser arm 6 is also able to remove at least one valve train component 3 from the load carrier 4, to feed the valve train component to the laser 5 and to hold it there during laser structuring and to subsequently put it back again into the load carrier 4.

According to an advantageous refinement of the solution according to the invention, at least two lasers 5 can also be provided (cf. FIG. 2) by means of which simultaneous laser structuring of at least one valve train component 3 can be carried out. Here, it is conceivable that the at least two lasers 5 are arranged side by side or above and below the valve train component 3 to be machined. Moreover, the at least one robot arm 6 can be movable, for example for the purpose of reducing gripping time for gripping the valve train component 3 to be machined in the load carrier 4 and for feeding it to the laser 5. “Movable” in this context means that the robot arm 6 as a whole can be moved, for example, on wheels.

According to FIG. 2, a device 1 is shown which includes not only two lasers 5, but also two robot arms 6 each having a gripping device 7, wherein the one robot arm 6, for example, removes a valve train component 3 to be machined from the load carrier 4 and feeds it to the laser 5, while the other robot arm 6, at the same time, holds the valve train component 3 to be machined during the laser structuring.

Moreover, on at least one of the robot arms 6, a camera 8 can be arranged, which is able to detect a position of the valve train component 3 to be gripped and to align and readjust the gripping device 7 via a control device 9 upon detection of a positional deviation. Through this it can always be ensured that the valve train component 3 to be machined can be reliably and exactly gripped and fed in an exact position to the laser 5 where it can be laser-structured with precision.

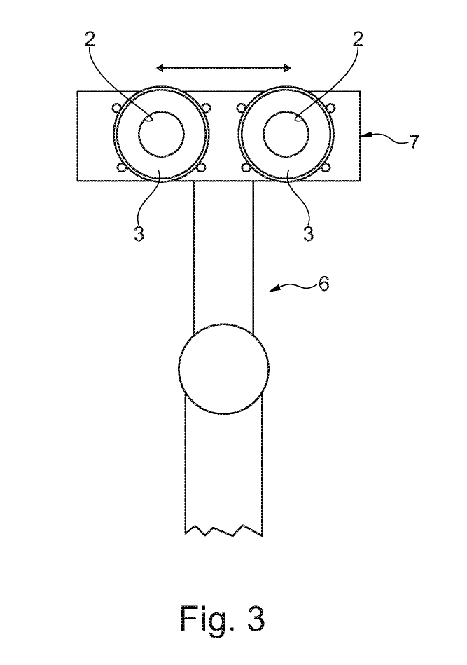

FIG. 3 shows, for example, a part of the robot arm 6 with a gripping device 7 which is arranged at the end of the robot arm and which is capable of simultaneously gripping two valve train components 3 to be machined. If an adequate number of lasers 5 is arranged in the respective laser station, it is possible to simultaneously laser-structure two or more valve train components 3. In general, the control device 9 can additionally include a monitoring device 10 which generates an optical and/or acoustic monitoring signal, provided that the laser structuring process has been performed correctly. Such a control signal can of course also be included in a quality assurance protocol, whereby permanent quality assurance is possible.

When laser structuring a hub 2 of at least one valve drive component 3 using a previously described device 1, first, in a first work step, at least one valve train component 3 to be lasered is provided in a suitable load carrier 4. Subsequently, the robot arm 6 together with its gripping device 7 is moved to the load carrier 4 and in the process of this, the gripping device 7 is appropriately aligned with respect to the valve train valve component 3 by means of the camera 8 and the control device 9. Subsequently, the gripping device 7 can grip the at least one valve train component 3, remove it from the load carrier 4 and feed it to the laser 5 in a first machining position. In this first machining position, the at least one valve train component 3 is laser-structured by means of at least one laser 5, that is, a certain roughness is introduced on an inner surface of the hub 2. Subsequently, the gripping device 7 can feed the at least one valve train component 3 to a second or further machining position in which at least one second laser 5 or a further laser 5 further laser-structures the valve train component 3. Finally, the gripping device 7 puts the at least one valve train component 3 back into the load carrier 4.

It is clear, of course, that the device 1 according to the invention can include not only one but a plurality of robot arms 6 comprising one or more gripping device(s) 7, as well as one or a plurality of lasers 5, whereby simultaneous laser structuring of a plurality of valve train components 3 is possible. By means of the device 1 according to the invention, it is possible to achieve not only effective, but also particularly flexible laser structuring of valve train components 3 since in the case of different valve train components 3, only the programming of the robot arm 6 and/or the gripping device 7 and/or the laser 5 needs to be adapted accordingly.

1. A device for laser structuring hubs of a valve train component, comprising:
at least one load carrier for storing and providing at least two valve train components,
at least one laser for laser structuring a hub of at least one of the valve train components,
at least one robot arm having at least one gripping device for gripping, positioning and holding the at least one valve train component during the laser structuring, wherein the at least one robot arm is configured to remove the at least one valve train component from the load carrier and feed the at least one valve train component to the laser.

2. The device according to claim 1, wherein at least two lasers are provided for simultaneously lasering the at least one valve train component.

3. The device according to claim 1, wherein at least two lasers are provided, wherein one of the lasers is arranged above the valve train component to be machined and another laser is arranged below the valve train component to be machined.

4. The device according to claim 1, wherein the at least one robot arm is movable.

5. The device according to claim 1, further comprising a camera for detecting the position of the at least one valve train component, wherein the camera is arranged on the at least one robot arm.

6. The device according to claim 5, further comprising a control device communicatively connected to the camera and configured to readjust the gripping device upon detection of a positional deviation.

7. The device according to claim 6, wherein the control device includes a monitoring device configured to transmit at least one of an optical monitoring signal and an acoustic monitoring signal in response to completing the laser structuring of the hub.

8. A laser structuring method for a hub of a valve train component, comprising:
placing at least one valve train component to be lasered on at least one load carrier,
moving at least one robot arm including a gripping device to the at least one load carrier,
localizing via a camera operatively coupled to a control device the at least one valve train component to be gripped and aligning the gripping device accordingly,
gripping via the gripping device the at least one valve train component and positioning the at least one valve train component to a machining position,
laser-structuring via at least one laser the at least one valve train component,
positioning via the gripping device the at least one valve train component to a second or further machining position,
laser-structuring via the at least one laser the at least one valve train component in the further machining position, and
placing via the gripping device the at least one valve train component back into the at least one load carrier.

9. The method according to claim 8, further comprising transmitting at least one of an optical monitoring signal and an acoustic monitoring signal in response to completing the laser-structuring of the at least one valve train component.

10. The device according to claim 1, wherein the at least one laser includes a 3D laser.

11. The device according to claim 2, wherein one of the at least two lasers is arranged above the valve train component to be machined and another of the at least two lasers is arranged below the valve train component to be machined.

12. The device according to claim 11, wherein the at least two lasers are 3D lasers.

13. The device according to claim 2, wherein the at least one robot arm is movable.

14. The device according to claim 13, further comprising a camera for detecting the position of the at least one valve train component, wherein the camera is arranged on the at least one robot arm.

15. The device according to claim 14, further comprising a control device in communication with the camera and configured to readjust the gripping device upon detection of a positional deviation.

16. The device according to claim 3, wherein at least one of the lasers is a 3D laser.

17. The device according to claim 4, further comprising a camera for detecting the position of the at least one valve train component, wherein the camera is arranged on the at least one robot arm.

18. The device according to claim 17, further comprising a control device in communication with the camera and configured to readjust the gripping device upon detection of a positional deviation.

19. The device according to claim 18, wherein the control device includes a monitoring device configured to transmit at least one of an optical monitoring signal and an acoustic monitoring signal in response to completing the laser structuring of the hub.

20. A laser structuring device for a valve train component, comprising:
a load carrier configured to hold at least one valve train component;
at least one laser configured to laser structure a hub of the at least one valve train component;
a movable robot arm including at least one gripping device configured to grip, position and hold the at least one valve train component, wherein the robot arm is configured to move the at least one valve train component from the load carrier to a machining position relative to the at least one laser; and
a camera disposed on the robot arm for detecting a position of the at least one valve train component.
